(19) United States
(12) Patent Application Publication
(10) Pub. No.: US 2018/0001565 A1
(43) Pub. Date: Jan. 4, 2018

(54) IDENTIFYING A CHARACTERISTIC OF A MATERIAL FOR ADDITIVE MANUFACTURING

(71) Applicant: SABIC GLOBAL TECHNOLOGIES B.V., Bergen op Zoom (NL)

(72) Inventor: Thomas Hocker, Pittsfield, MA (US)

(21) Appl. No.: 15/537,262

(22) PCT Filed: Dec. 1, 2015
(86) PCT No.: PCT/IB2015/059266

§ 371 Date: Jun. 16, 2017

Related U.S. Application Data
(60) Provisional application No. 62/092,976, filed on Dec. 17, 2014.

(51) Int. Cl. B29C 64/393; B33Y 50/02; G01B 11/24; G01N 23/223

(52) U.S. Cl. CPC B29C 64/393; G01N 23/223; B33Y 50/02; G01B 11/24; G01N 2223/645

(57) ABSTRACT

Systems, devices, and methods according to the present disclosure are configured for use in additive manufacturing, e.g. 3D printing. Various materials, including thermoplastic materials, can be used with an additive manufacturing system to create a part composite. Systems, devices, and methods described herein can be used to identify a characteristic of a material or of a material container for use with an additive manufacturing system. The identified characteristic can be used to determine an authenticity of the material. Based on the authenticity, one or more features or functions of the additive manufacturing system can be updated. The characteristic of the material may be optical information on the container of the material, e.g. a bar code, may be identified by emitting x-ray radiation and receiving a spectral characteristic, may be an electrical or magnetic characteristic or may be engraved on the surface of the material itself.

### CLAIM OF PRIORITY

This application claims the benefit of priority under 35 U.S.C. § 119(e) of Hocker, U.S. Provisional Patent Application Ser. No. 62/092,976, filed on Dec. 17, 2014, which is herein incorporated by reference.

### BACKGROUND

Additive manufacturing, or three-dimensional (3D) printing, is a production technology for making a solid object from a digital model. Generally, computer-aided design (CAD) modeling software is used to create the digital model of a desired solid object. Instructions for an additive manufacturing system are then created based on the digital model, for example by virtually “slicing” the digital model into cross-sections or layers. The layers can be formed or deposited in a sequential process in an additive manufacturing device to create the object.

Various polymers can be used in additive manufacturing, including polymers having different colors, weights, flame resistance capabilities, or other characteristics. Some part composites are made using a monofilament additive manufacturing technique (for example, fused deposition modeling (FDM) or fused filament fabrication (FFF)). A monofilament, or filament, can include a material strand that is about 0.1 to 3.0 mm in diameter. Some filament materials can bond under heat and atmospheric pressure to create a part composite that has a high degree of interaction between strand surfaces, with a small portion of voids in the bonded strands.

Filament material can be coiled and stored on a spool. A spool can be housed in a cartridge container, such as for preventing the filament from unspooling, or for protecting the filament from environmental conditions, such as moisture or UV light. In an example, a cartridge includes an electrically erasable programmable read-only memory (EEPROM). The EEPROM can store information about a cartridge, including information about a quantity of monofilament material available in the cartridge. An additive manufacturing system can be configured to record information, such as received from various EEPROMs, about one or more cartridges used with the system. The system can lock out any unrecognized or unauthorized cartridge from use with the system. The system can be further configured to inhibit re-use of cartridges that may include re-spooled filament material, that is, filament material from an unknown or unapproved supplier, or filament material that is wound on a spool that was previously used.

### Overview

The present subject matter includes systems, methods, and devices for authentication, verification, and validation of materials for use in additive manufacturing. Additive manufacturing, also referred to as 3D printing, additive printing, fused deposition modeling, or direct digital printing, can be used for prototyping or manufacturing using a range of different materials. Some materials include, but are not limited to, polymers, thermoplastics, composites, and alloys.

Materials used in additive manufacturing can be supplied to an additive manufacturing system in various forms or configurations. For example, a thermoplastic filament material can be used. The filament can be provided in a canister, on a spool, or on a spool within a cartridge container. In other examples, the material can be in the form of a pellet, powder, ribbon, stick, rod, or other shape.

A characteristic, quality, or source of a material can be identified or verified in different ways. For example, an additive manufacturing system can include a sensor to sense or read information either directly from the material itself, or from a container that includes the material. In an example, a bar code, or other pattern, can be printed on, etched in, or otherwise provided with one or both of the material and the container. The bar code or other pattern can encode information about a characteristic of the material. The encoded information can include, among other things, information about a material type, color, manufacturer or other source information, lot number, or material or cartridge serial number.

Using the information from the sensor about the material or about the container holding the material, a portion of an additive manufacturing system can be configured to verify an authenticity or source of the material or of the container holding the material. Based on the results of the verification, the additive manufacturing system can take some action or alter a capability or characteristic of the system. For example, in response to identifying an unapproved or counterfeit material, the system can display a warning message, or can lock-out print capabilities. In an example, the additive manufacturing system can be coupled to a network, and the information from the sensor can be communicated from the additive manufacturing system to a remote device on the network. In response, the remote device can provide instructions to the additive manufacturing system, such as to take some action or to alter a capability or characteristic of the system.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an example of an additive manufacturing system and a control circuit.

FIG. 2 illustrates generally an example that includes generating an authentication score based on a material characteristic.

FIG. 3 illustrates generally an example of an additive manufacturing system with an authentication device.

FIG. 4 illustrates generally an example that includes authenticating a material.

FIG. 5 illustrates generally an example of multiple filament cross-section shapes.

FIG. 6 illustrates generally an example of a filament segment having multiple different cross-section shapes along the filament segment's length.

FIG. 7 illustrates generally an example of a filament with multiple grooves.

FIG. 8 illustrates generally an example of measuring a bend characteristic of a material.

FIG. 9 illustrates generally an example of measuring an electrical characteristic of a material.

FIG. 10 illustrates generally an example of measuring a fluorescence characteristic of a material.

FIG. 11 illustrates generally an example of a filament with a surface tag.

### DETAILED DESCRIPTION

This detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventor also contemplates examples in which only those elements shown or described are provided. Moreover, the present inventor also contemplates examples using any combination or permutation of the elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the claims, the terms “first,” “second,” and “third,” etc. are used merely as labels, and are not intended to impose numerical requirements on their objects.

Systems, devices, and methods according to the present disclosure are configured primarily for use in additive manufacturing (AM), also referred to as material extrusion additive manufacturing, deposition modeling, or three-dimensional (3D) printing. Without limiting the scope of the present disclosure, systems for additive manufacturing can include stand-alone manufacturing or printing units, a series of units on an assembly line, or a high volume system for additive manufacturing that includes one or more workflow automation features such as a conveyor for transporting parts to or from a build area, or a robot arm for transporting parts or adjusting a system component.

Polymeric materials can be used in the additive manufacturing systems described herein. Polymeric materials can include high-performance engineering thermoplastic polymers such as polycarbonate-based polymers (PC), polymethyl methacrylate polymers (PMMA), polyethylene terephthalate polymers (PET), styrene polymers, and acrylonitrile-butadiene-styrene polymers (ABS), among others. Polymeric and other materials, such as those suitable for use with the additive manufacturing systems and methods of the present disclosure, are discussed at length below.

Additive manufacturing systems can include, among others, systems configured to perform fused deposition modeling, or FDM. FDM is an additive process in which layers of material are successively deposited and fused together to form a part composite. Materials suitable for FDM include production-grade thermoplastics such as ABS, polycarbonate (PC), and polyetherimide (PEI, Ultem), among others. Support material used in FDM can optionally be water based.

The present inventor has recognized that some materials may not be suited for use with some additive manufacturing systems. For example, a nozzle cartridge configured to dispense a first thermoplastic material (e.g., having a first material characteristic, such as a first melting temperature) in an additive manufacturing system may not be suitable for dispensing a different second thermoplastic material (e.g., having a different second material characteristic, such as a different second melting temperature that is higher than the first melting temperature), or for dispensing an alloy material.

The present inventor has further recognized that a supplier of an additive manufacturing system may have an interest in producing or incentive to produce a system that is configured to function with only specified or approved materials. In some examples, a supplier of an additive manufacturing system may also supply material for use with the system, or the system supplier can license to others a right to produce or supply material that is approved for use with the system. The systems, devices, and methods described herein can help to authenticate materials, or to verify compatibility between materials and systems. An additive manufacturing system according to the present disclosure can use information about the authenticity or compatibility of a material to influence operation of the system, for example, to prevent unsuitable materials from being used with a particular, non-compatible additive manufacturing system.

The word “authentication” and variations thereof are used throughout the present disclosure to refer to identifying a characteristic of a material, or of another device or part for use in or with an additive manufacturing system. Authentication can include identifying one or more of a material type, composition, configuration, source, or other material characteristic. In an example, authentication includes verifying or confirming that a measured or observed characteristic of a material corresponds with an expected characteristic of the material. Authentication can include determining whether a stated or expected characteristic of a material is accurate, or authentication can include determining whether a material originates from an expected source.

The systems and methods described herein can be configured to assign or generate an authentication score that can be associated with a measured or observed material. The authentication score can include binary or yes/no information about whether a particular material corresponds to some specified or expected material. In some examples, the authentication score includes a relative indication, a likelihood, or a confidence level indicator, to indicate whether the measured or observed characteristic of the material corresponds to an expected characteristic or to a characteristic indicative of an expected material.

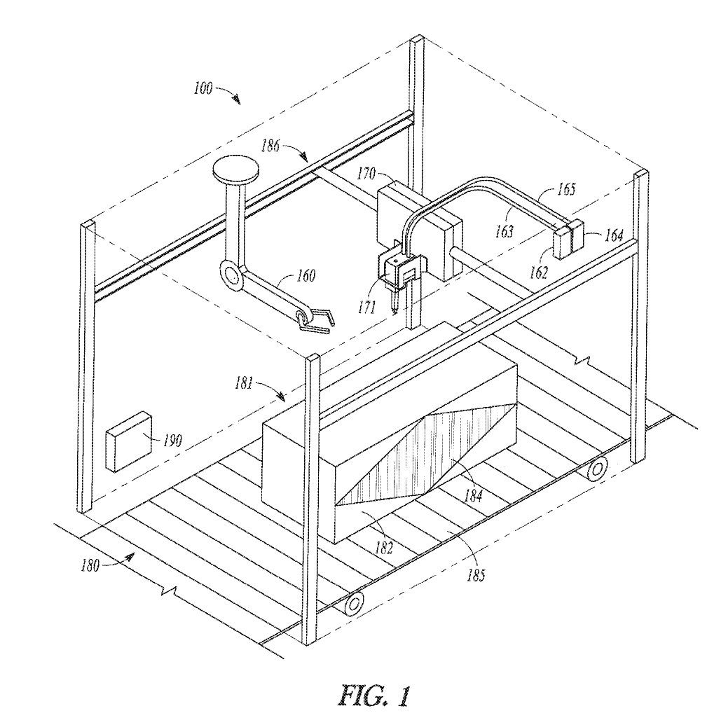

Various additive manufacturing systems can be used with the systems, methods, and devices described herein for material authentication. For example, FIG. 1 illustrates generally an example of a portion of an additive manufacturing system 100 that can be used. The system 100 includes a build area 180, a movable extrusion head assembly 170, and a system control circuit 190.

The extrusion head assembly 170 is movable within the build area 180 in response to instructions from the system control circuit 190. The system control circuit 190 can include, among other things, a processor circuit or information gateway that can provide instructions to the extrusion head assembly 170, or to other portions of the system 100, and the instructions can be interpreted and used by one or more portions of the system 100 to create or process a part composite 181. The part composite 181 can include one or more of a support material 182 and a model material 184. In an example, multiple different support or model materials can be used to create the part composite 181.

The extrusion head assembly 170 can include, or can be configured to be coupled to, one or more nozzle cartridges. For example, the extrusion head assembly 170 can include a nozzle cartridge chassis that is configured to receive and retain a nozzle cartridge for use in a build event. A nozzle cartridge generally includes a raw material input, a liquefier for heating successive portions of raw material, and a nozzle tip for dispensing the heated material. In some examples, the nozzle cartridge is configured to receive a polymer filament at the raw material input. A nozzle cartridge can be configured to dispense multiple different types of materials, or a nozzle cartridge can be configured to dispense a specified single material. In an example, a nozzle cartridge can include a nozzle tip that is configured for dispensing a specified material, or range of materials, at a specified material dispensing rate or at a specified temperature.

The extrusion head assembly 170 can optionally include a liquefier assembly, a temperature control device, or a drive assembly. The liquefier assembly can be used to liquefy a material supplied (e.g., in filament form) to the extrusion head assembly 170 from a material source. The temperature control device can optionally be used to control heating of the liquefier assembly or of a portion of a nozzle cartridge that is installed in a chassis of the extrusion head assembly 170.

The build area 180 can include, among other features, a build sheet 185 and an x-y gantry 186. In some examples, the build sheet 185 includes a portion of a conveyor belt surface, and the conveyor belt is movable from the build area 180 to one or more downstream part composite processing areas. The build sheet 185 can optionally be movable along a vertical z-axis, such as in response to instructions received from the system control circuit 190, such as by adjusting a vertical position of a platform or, in the case of a conveyor, by adjusting one or more rollers upon which the belt moves.

The x-y gantry 186 can include a guide rail system that is configured to move the extrusion head assembly 170 in a horizontal x-y plane within the build area 180. In some examples, the x-y gantry 186 or the extrusion head assembly 170 can be additionally movable along the vertical z-axis. In some examples, the build sheet 185 can be movable in the horizontal x-y plane within the build area 180, and the extrusion head assembly 170 can be movable along the vertical z-axis. Other arrangements can additionally or alternatively be used such that one or both of the build sheet 185 and the extrusion head assembly 170 are moveable relative to the other. In the example of FIG. 1, the extrusion head assembly 170 is movable in the horizontal x-y plane to create the part composite 181 in a layer-by-layer manner using one or more of the model material 184 and the support material 182.

The first nozzle cartridge 171 can be configured to receive multiple filament materials. A support material filament can be routed from a support material source 162, optionally using a first filament conduit 163, to the first nozzle cartridge 171. A model material filament or part material filament can be routed from a model material source 164, optionally using a second filament conduit 165, to the first nozzle cartridge 171. The material sources can include respective spools of filament polymer (and/or other material) that can be driven or drawn through the respective filament conduits to the first nozzle cartridge 171.

Raw material for use in additive manufacturing, such as the support and model materials 182 and 184, can be provided to the system 100 in various media or configurations. For example, the materials can be supplied in the form of a continuous filament, such as on a spool in a filament cassette. A filament, such as having a circular cross section, can have any one or more of various diameters, such as ranging from about 1 millimeter or less to about 3 millimeters or more. FIG. 1 illustrates generally the system 100 as using bulk material supplied in filament form, however, other forms of material can be used. For example, raw material can be supplied to the system in the form of a liquid, block, powder, pellet, stick, rod, or other shape.

Raw material for use in additive manufacturing can be processed intermediately between its source container and the system 100. For example, the material can be processed to change a characteristic of the supplied raw material into another form that is usable by the system. In some examples, a material supplier provides the raw material in a form ready for use in the additive manufacturing system. In an example, intermediate material processing includes loading the material onto a spool, into a canister or cartridge, or into a portion of the additive manufacturing system. In other examples, intermediate material processing can include mixing or doping a material before it is used in the system 100.

At the material manufacturer, at an intermediate processor, or at the additive manufacturing system, one or more properties of the material can be measured for authentication or verification. For example, a material composition can be analyzed. A specified volume of the material can be weighed, such as to determine a material density. A test portion of the material can be analyzed, such as optically or using X-ray fluorescence to discern elemental constituents or other chemical properties or signatures of the material. Other tests or measurements can similarly be used. The result of such test or measurement can be used to authenticate or verify that the tested material is suitable for use with a specified system.

If a filament or other strand-based material is used, it can be loaded onto a spool or into a container, and the material and/or container can itself be authenticated. In an example, the material and/or container can be authenticated at the additive manufacturing system when the spool or container is positioned in a designated storage or use location within the system. The material and/or container can be additionally or alternatively authenticated at an interface or other material exchange location between the spool (container, or other storage means) and the system. The material can be additionally or alternatively authenticated inside of the additive manufacturing system, such as using an authentication device positioned between the material supply and one or more nozzle cartridges, such as at an extrusion head assembly.

After authenticating the material(s) to be used in a build event, support material 182 or model material 184 can be deposited onto the build sheet 185 to create the part composite 181. As referred to herein, a part composite can include one or both of the support material 182 and the model material 184. Generally, support material 182 is deposited to provide vertical support along the z-axis, such as for overhanging portions or layers of the model material 184. After a layer is deposited, or after a build operation is completed, the resulting part composite 181 can be removed from the build area 180, such as manually by an operator, automatically using a conveyor that includes the build sheet 185, automatically using a robotic arm, or using some other device to relocate the part composite 181. The support material 182 can be separated from the model material 184 before or after the part composite is removed from the build area 180. In some examples, the support material 182 can be automatically removed, dissolved, or otherwise detached from the model material 184. Systems and methods for automatically removing support material 182 are described in Hocker, U.S. Provisional Patent Application No. 62/085,833, titled “ADDITIVE MANUFACTURING PROCESS AUTOMATION SYSTEMS AND METHODS”, which is hereby incorporated herein by reference in its entirety.

The control circuit 190 can include a processor circuit or a software module (e.g., code embodied (1) on a non-transitory machine-readable medium or (2) in a transmission signal) or a hardware-implemented module. A hardware-implemented module can include a tangible unit capable of performing various, programmable operations. In some examples, one or more computer systems (e.g., including a standalone, target or server computer system) or one or more processor circuits may be configured by software (e.g., an application or application portion) as a hardware-implemented module that operates to perform operations as described herein.

In some examples, the hardware-implemented module can be implemented mechanically or electronically. For example, the hardware-implemented module can include dedicated circuitry or logic that is permanently configured, for example, as a special-purpose processor circuit, such as a field programmable gate array (FPGA) or an application-specific integrated circuit (ASIC), to perform specified operations. The hardware-implemented module can include programmable logic or circuitry (e.g., as encompassed within a general-purpose processor or other programmable processor) that can be temporarily configured by software to perform certain operations. The decision to implement a hardware-implemented module mechanically, in dedicated and permanently configured circuitry, or in temporarily configured circuitry (e.g., configured by software) may be driven by cost and time considerations.

The various operations and methods described herein may be performed, at least partially, by one or more control or processor circuits that are temporarily configured (e.g., by software) or permanently configured to perform the relevant operations. Whether temporarily or permanently configured, such processor circuits may constitute processor-implemented modules that operate to perform one or more operations or functions. The performance of certain ones of the operations described herein can optionally be distributed among two or more processors or control circuits, not only residing within a single machine, but deployed across a number of machines, such as including in different portions of an additive manufacturing system. For example, although referred to generally herein as a control circuit 190, the circuit can include a module at or near the build area 180 to provide feedback or instructions to the extrusion head assembly 170 about a built event status, and the circuit can include a module in a post-processing or other downstream area of the system.

Some parts can be made from multiple different raw materials, including materials having different shapes, different chemical structures, different melting points, different extrusion or curing characteristics, different colors, or other different characteristics. In some examples, efficiencies can be gained by dedicating or configuring a specified nozzle cartridge for depositing a specified type of material, rather than to change one or more operating characteristics (e.g., a liquefier operating temperature, an extrusion tip configuration, a drive mechanism, etc.) of that nozzle cartridge at each material change. In systems where a nozzle cartridge is dedicated to dispensing a particular material, material supply efficiencies can be realized as raw materials do not need to be routinely purged from a supply conduit or liquefier assembly at a material change event. One or more nozzle cartridges having dedicated material supplies or operating characteristic set points can be stored in a holding area, such as in or near the build area 180 of the system 100, until such nozzle cartridge is needed in a build process. Once a specified nozzle cartridge (or corresponding material type) is indicated for use, the nozzle cartridge can be automatically prepared (e.g., preheated) or coupled to the extrusion head assembly 170 and then used to deposit its corresponding material. In this manner, a build process can seamlessly, and without user intervention, use multiple different material types, applied in multiple different ways, without delays during changeovers or system reconfigurations, such as due to preheating lag times. Systems and methods for using multiple nozzle cartridges in coordination with a nozzle tray are described in Hocker, U.S. Provisional Patent Application No. 62/085,843, titled “NOZZLE TOOL CHANGING FOR MATERIAL EXTRUSION ADDITIVE MANUFACTURING”, which is hereby incorporated herein by reference in its entirety.

One or more materials for use with the system 100 can be authenticated prior to use in the system 100. For example, a material type can be authenticated to disable a system lock-out or before a system can proceed with a build event. In an example, a material must be authenticated before a drive assembly or liquefier assembly (or other critical component) of the system 100 is enabled or activated.

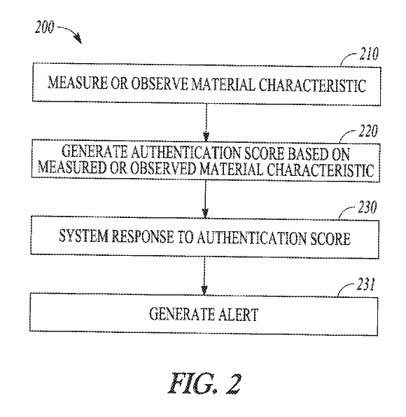

FIG. 2 illustrates generally an example 200 of a method for authenticating a material and providing a system response. At 210, the method for authenticating a material includes using a component of the system 100, or using a component that is communicatively coupled with the system 100, to measure or observe a characteristic or property of a material to be used in the system 100, or to measure or observe a characteristic of a container that includes the material to be used in the system 100. The component of the system 100 for use in measuring or observing a characteristic of a material can include, among other things, a mechanical, optical, chemical, or other sensor that is communicatively coupled with the control circuit 190.

At 220, an authentication score can be generated in response to the measurement or observation. The authentication score can be generated using the processor circuit 190, or some other device, module, or algorithm that is configured to compare information about the measured or observed characteristic value from 210 with an expected or reference characteristic value. In an example, the authentication score includes a binary or yes/no response that is based on the measurement or observation. In other examples, the authentication score includes a relative indication or a likelihood (e.g., a confidence level) that the measured or observed characteristic of the material corresponds to an expected characteristic, or to a characteristic indicative of an authentic material. In an example, the authentication score includes information about a similarity between an observed characteristic value and a reference value.

Cowburn et al., in U.S. Pat. No. 8,078,875, titled “Verification of authenticity”, which is hereby incorporated herein by reference in its entirety, refers to using blocks of characteristic information for article identification. Cowburn et al. further refers to determining a similarity result, and successfully identifying an article that has been damaged by stretching or shrinking.

At 230, an additive manufacturing system, a networked software application, or other component of the system can take some action in response to the authentication score generated at 220. For example, the system, application, or other component can enable or disable a feature of the additive manufacturing system, adjust a print quality or print feature, or otherwise update or adjust a print capability of the additive manufacturing system. Alexia et al., in U.S. Pat. No. 7,048,366, titled “Secure Printer Cartridge”, which is hereby incorporated herein by reference in its entirety, refers to analyzing printing commands for controlling a print head to authenticate data to be printed. As described herein, material authentication information can be similarly analyzed for controlling an extrusion nozzle in an additive manufacturing system.

At 231, the method can include generating and optionally sending an alert, such as via email, to an operator, to the system operator, to the system manufacturer, to the material manufacturer, or to issue an audible or visual alert using a speaker or display (e.g., a light) coupled to the system. The alert can include information about a system operation status, or about the authentication score.

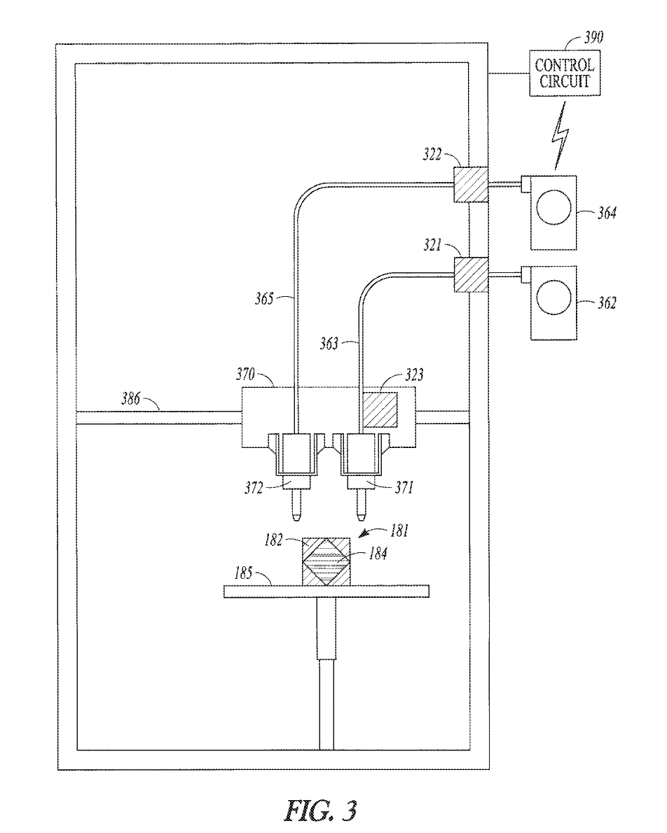

FIG. 3 illustrates generally an example of a system 300 that includes an authentication device to measure or observe a characteristic of a material for use in the system 300. In the example of FIG. 1, a second extrusion head assembly 370 includes first and second nozzle cartridges 371 and 372, such as configured to receive respective first and second materials from respective first and second material sources 362 and 364. A first material can be routed from the first material source 362, optionally using a first filament conduit 363, to the first nozzle cartridge 371. A second material filament can be routed from the second material source 364, optionally using a second filament conduit 365, to second nozzle cartridge 372. The material sources can include respective spools of filament polymers that can be driven or drawn through the respective filament conduits to the first and second nozzle cartridges 371 and 372.

The system 300 includes first and second authentication devices 321 and 322. Although two authentication devices are shown, such as corresponding to the two material sources 362 and 364, a single authentication device could be similarly used. For example, material from each of the first and second material sources 362 and 364 can be supplied to respective inputs on a single authentication device. In an example, a material flow control system can be provided to serially provide material from one or the other of the first and second material sources 362 and 364 to a common input of a single authentication device, and then to redistribute an output of the single authentication device to one of the first and second nozzle cartridges 371 and 372. In an example, the flow control system can be configured to periodically or intermittently sample material from the first and second material sources 362 and 364, such as during a build event.

In the example of FIG. 3, the first authentication device 321 is provided at an interface between the first material source 362 and the first filament conduit 363. In this example, the first material source 362 is shown to be outside of the system 300 and the first filament conduit is shown to be inside of the system 300, however, other configurations can similarly be used. The first authentication device 321 can receive a sample of the first material from the first material source 362 and can measure or observe one or more characteristics or properties of the first material. The first authentication device 321 can operate substantially in accordance with the example of FIG. 2. Information from the first authentication device 321 can be communicated to a control circuit 390.

In an example, an authentication device can be located at another location in the system 300. For example, an authentication device can be located intermediately along the first material conduit 363 between an input for the first material and the first nozzle cartridge 371. That is, an authentication device can be positioned or configured to sample the first material at some point along the first material conduit 363 that is between the material input and the nozzle cartridge. In an example, an authentication device can be integrated with one of the extrusion head assembly 370 and the first nozzle cartridge 371, such that the first material is authenticated before, during, or after liquefaction at the first nozzle cartridge 371. In FIG. 3, a third authentication device 323 is integrated with the extrusion head assembly 370 and is configured to authenticate material from the first material conduit 363 before the material reaches the first nozzle cartridge 371.

The system 300 includes the control circuit 390. The control circuit 390 can correspond functionally or physically to the control circuit 190 described above in the example of FIG. 1. The control circuit 390 can be configured to exchange information with the first or second material sources 362 and 364, such as via a wired or wireless communication path. In an example, the first material source 362 includes an RFID tag that is responsive to an interrogation or request from an RFID excitation circuit in the control circuit 390. In an example, the first material source 362 includes a memory circuit or other processor circuit that is configured to exchange information with the control circuit 390 about one or more pre-programmed characteristics of the first material source 362 or the first material included inside of the first material source 362. In an example, the RFID tag, memory circuit, or other processor circuit is included on a spool or other material container inside of the first material source 362.

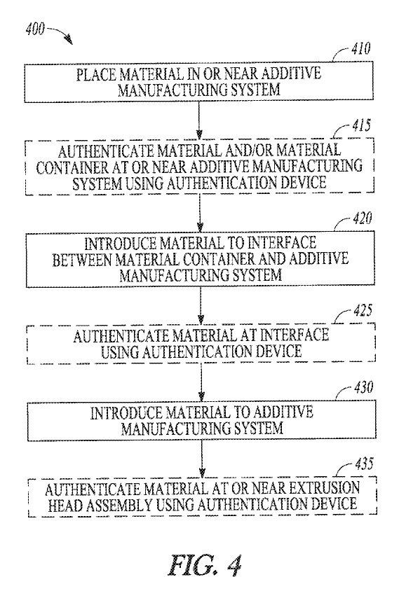

FIG. 4 illustrates generally an example 400 that includes using an authentication device, such as using one of the first, second, or third authentication devices 321, 323, or 323 in the example of FIG. 3, among others. At 410, the example 400 includes placing material in or near an additive manufacturing system. Placing material in or near an additive manufacturing system can include providing a spool of material, a material cartridge, a material cassette, or other material-holding container in a receptacle that is associated with an additive manufacturing system. For example, an additive manufacturing system can include a cassette receptacle that is sized and shaped to receive a material cassette, and the material cassette can include a spool of filament material inside of the cassette's housing. In an example, placing the material in or near an additive manufacturing system at 410 includes filling a hopper or other receptacle with a material in liquid, pellet, powder, or other form.

At 415, the example 400 optionally includes authenticating the material, or authenticating a container containing the material, when the material is positioned at or near the additive manufacturing system. As explained above in the example of FIG. 3, the control circuit 390, or other circuit or module, can be configured to communicate with a corresponding circuit in the material container to receive information about, and authenticate, a material. In an example, the authentication at 415 can include using a sensor coupled to the additive manufacturing system to observe a visual characteristic of the material and/or the material container that is at or near the additive manufacturing system.

At 420, the example 400 includes introducing material to an interface between a material container and an additive manufacturing system. For example, introducing the material can include threading a filament into an input port of the additive manufacturing system. An authentication device can be positioned at the input port of the system, such as shown in the example of FIG. 3 at 321. At 425, the example 400 optionally includes authenticating the material at the interface using the authentication device.

At 430, the example 400 includes introducing material into an additive manufacturing system. At 435, the example 400 can include authenticating the material at or near an extrusion head assembly using the authentication device. As similarly described above in the discussion of FIG. 3, an authentication device can be located intermediately between a material input and a nozzle cartridge inside of an additive manufacturing system. In an example, the authentication device can be integrated with one of an extrusion head assembly and a nozzle cartridge such that a material can be authenticated before, during, or after liquefaction at a nozzle cartridge.

The example 400 includes multiple different authentication steps (e.g., at 415, 425, and 435) that can be performed using the same or different authentication technique or device. In an example, each of the multiple different authentication steps in FIG. 4 can be performed. In other examples, only one or two of the authentication steps can be performed.

Authenticating a material for use in additive manufacturing can include selecting for use one or more measurable characteristics or properties of the material, or one or more measurable characteristics or properties of a container that includes the material. The selected measurable characteristic can depend in part on a location or step in an additive manufacturing system, or can correspond to a specified state of the material itself (e.g., solid, liquefied, or in transition between states). A measurable characteristic of a material can include a physical, chemical, electrical, magnetic, visual, or other feature that is characteristic of the material itself. The characteristic can be inherent, such as corresponding to a property of the material at some baseline or reference environmental condition (e.g., at 30 degrees Celsius, at atmospheric pressure, and at 30% relative humidity). In an example, a material characteristic can be a transient or permanent response of the material to one or more external factors, such as a response of the material to exposure to one or more of a chemical, heat, UV light, or a response to some other interrogation of the material itself, such as a response to a bend or deformation test. The material characteristic or response can be optionally observed in response to a test, including in response to contact with a test material or under the influence of an outside force that is provided for the purpose of discerning a material property, such as to distinguish an authentic material from a counterfeit material.

A measurable material characteristic can be intentionally added during material manufacture. For example, a measurable characteristic can include a dopant level, and a material can be doped with an impurity at some constant or variable rate or concentration, such as over a length of a filament. In an example, a measurable characteristic can be a result or by-product of a manufacturing process associated with the material, whereby a particular method of manufacture results in a unique characteristic that can be used to authenticate a material.

A material characteristic can be uniform throughout the material, or it can vary. In an example that includes a material filament, different sections of the filament can have different characteristics. The different characteristics can indicate or encode information about an authenticity of a material. For example, a specified change in a specified material characteristic, such as over a specified material length, can be used to indicate a material type, material source, or other indication of a material authenticity. In an example, information about a material characteristic change pattern or sequence can be stored on a remote server, accessible using an additive manufacturing system. Information about an observed material characteristic or sequence of material characteristics can be shared with the remote server, and the remote server can provide the information about the authenticity of the material. The information about the authenticity of the material can be used by the system to update an operating characteristic of the system.

Different measureable characteristics of a material can be used for material authentication at different stages or locations in an additive manufacturing system. For example, a first measurable characteristic can be used at an input or raw material stage, or at a precursor material stage, such as when forming the material or when loading the material into a container. A same or different second measurable characteristic can be used at an interface between the container and the additive manufacturing system, and a same or different third measurable characteristic can be used inside of the system to authenticate a material. In an example, a same or different fourth measurable characteristic can be used at or near a nozzle cartridge or extrusion tip, such as after a material is liquefied and before the material is released from the extrusion tip. In an example, a measurable characteristic can include a characteristic that results from or is introduced by a printing or material release process itself. For example, a material cooling profile or an extruded material shape at or near the extrusion tip can be used.

Information about a material characteristic can be encoded using the material itself, such as by etching, printing, doping, or otherwise recording some indicia on or in the material itself. The information can be decoded manually or automatically to authenticate the material, for example, before the material is used in an additive manufacturing build event. In an example, information about a material characteristic, referred to herein as a material “fingerprint”, can be stored on a record-bearing medium (e.g., a memory circuit) that is associated with the material or with a container that includes the material. Storing or recording the indicia can include safeguarding the data or information to prevent unauthorized access to the indicia, for example, using data encryption. The stored information can be retrieved, for example using an additive manufacturing system, and used to authenticate a material based on measured information about the material.

Authenticating a material based on a material characteristic can include identifying one or more of a type of a material or a source of a material, a manufacturer, a lot number, a date of production, or other information. Encoded information of a specified type may itself provide authentication of the material. For example, a particular order or sequence in which information is serially recorded along a filament length can be an indication of an authentic material. Authenticating the information can include comparing the measured or observed characteristic information with information from a source-identifying database, such as locally using a control circuit, or remotely using a network to transmit information about the taggant via a network. Cowburn, in U.S. Pat. No. 8,103,046, titled “Authenticity Verification of Articles Using a Database”, which is hereby incorporated herein by reference in its entirety, refers to authentication using information retrieved from a database.

Based on an authentication result, an additive manufacturing system or ancillary device can be configured to perform a specified task. The task can vary according to a stage of the additive manufacturing supply chain at which the authentication result is used or made available. For example, at a raw material stage, an indication of non-authentic or counterfeit material can result in a physical block or stop-use of the material in a material forming or container loading task. At a system loading or printing stage, an indication of non-authentic or counterfeit material can result in a termination of a build event, or can result in a change to an operating characteristic of the system. For example, the system can be modified to operate in a substandard or diminished print resolution or print capacity mode that will result in an inferior part composite form.

In an example, a failure to authenticate or decrypt information from a record-bearing material, container, or database can require action by a user to continue, or can automatically initiate a communication to the user or manufacturer to provide notification of the failure. Successful authentication or decryption of the authentication information can result in normal or enhanced system print quality and performance, or can enable ancillary features or printing capabilities.

In an example, use or attempted use of an unauthenticated material or material container can lock an additive manufacturing system and require a call to a call center or a request to an online service to obtain an unlock code. An unlock code or other information can be entered, such as manually by a user, or can be transmitted to the system by way of a network, to re-enable system operation. In an example, if the unauthenticated material continues to be used with the system, the system can operate in a low resolution or low density mode, or other diminished capacity mode. For example, the system can operate at a reduced speed resulting in longer build times.

Various other techniques can be used to compel a user to operate an additive manufacturing system with only approved or authentic materials. In an example, a system can use an unauthenticated material for only a portion of a build event and the system can then automatically interrupt, halt, or terminate the build event before the part composite is completed. Such a tactic can be an annoyance to users because of the time invested in producing the partial part composite. However, the tactic can be an effective way to compel future use of authentic materials with the system.

In an example, in response to an unauthenticated material, a system can generate a message to an operator to indicate that the part composite will have diminished quality. In an example, the system can generate a message to an operator to request that the material be replaced with authentic or genuine material. In an example, when an unauthentic material is detected, the system can be configured to automatically print or embed a disclaimer or other message or symbol on the final part composite, for example, “Manufactured using unauthorized material.”

One approach to authenticating a material includes using a measurable characteristic of a material itself. The characteristic can include a physical, chemical, electrical, magnetic, visual, or other feature that is measurable, optionally using an automatic sensor, and is characteristic of the material itself. Some measurable characteristics that can be used can be observed or measured as a result of a chemical or other material that is combined or mixed with, embedded within, formed, forged, cut, cast, molded, cross-linked, heat treated, chemically altered, imaged, printed upon, or otherwise added to the build material. Other measurable characteristics can include information, such as encoded information, that can be observed from the material itself as described below.

An observable or measurable characteristic can include a material shape, size, dimension, color and the like, or can include a tag, bar code, ink type or print pattern, watermark, or other indicia. A material characteristic can be measured and used to authenticate a material once, such as at an input to an additive manufacturing system, or a material characteristic can be measured at multiple different times or locations in an additive manufacturing system to provide continuous or intermittent authentication. More than one material characteristic can be measured at a given time or location, and the more than one characteristic, including combinations of multiple measured characteristics, can be used to authenticate a material.

In addition to authentication, information about a material can be used for tracking of material or products, manual and/or automatic selection of an operating mode for an additive manufacturing system, manual and/or automatic adjustment of system parameters in a given operating mode, consumables inventory, and the like. Blankenship, in U.S. Pat. No. 7,032,814, titled “Coded welding consumable”, and Stava, in U.S. Pat. No. 7,645,960, titled “Coded welding consumable”, which are hereby incorporated herein by reference in their entirety, refer to using information pertaining to a characteristic of a consumable material, such as to adjust one or more parameters in a process and/or to select between operating modes of a system. Blankenship and Stava explain that such characteristics can be encoded on a wire and/or on another memory component such as using a bar code label or tag, an RFID card or tag, or an IC card.

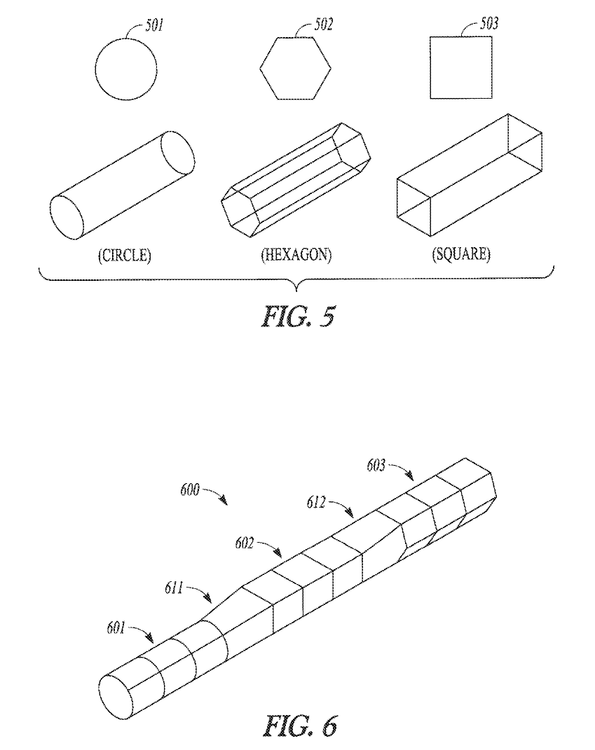

In an example, information about a material shape can be used to authenticate a material. For example, an authentication device or sensor can be configured to recognize a specified size, shape, dimension, cross-section, or other physical, dimension-based characteristic of a material, such as in pellet, filament, rod, or other material form. In an example, a filament can be formed from authentic material such that it has a polygonal cross-section, such as including at least one of a square, hexagon, trapezoid, star, or other cross-section. FIG. 5 illustrates generally examples that include profile and perspective views of filament materials having various cross-sections. FIG. 5 includes a filament having a circular cross-section at 501, a filament having a hexagonal cross-section at 502, and a filament having a square or rectangular cross-section at 503. An authenticity of the filament can be verified at a cartridge or container loading process, at a spool-winding process, or at a cartridge interface, such as using an optical sensor to verify the material shape. In an example, an additive manufacturing system can include an aperture at a material interface or material input port, and the aperture can be shaped correspondingly with the cross-section shape of the authentic material. The filament can be authenticated by passing (or attempting to pass) the filament through the aperture.

Jones, in U.S. Pat. No. 6,874,880, titled “Solid ink stick with an identifiable shape”, which is hereby incorporated herein by reference in its entirety, describes using a cross-section shape for authenticating dye sublimation printing materials. Jones et al., in U.S. Pat. No. 7,137,691, titled “Multiple segment keying for solid ink stick feed”, which is hereby incorporated herein by reference in its entirety, describes a verification method for solid ink sticks that includes a contoured ink stick aperture that is used to authenticate a material passed through the aperture. Some shapes of ink sticks are disclosed in U.S. Design Patent Nos. D379640, D383153, and D440248.

A feature on or in a material to be used in additive manufacturing can be used to identify or authenticate the material. For example, Jones, in U.S. Pat. No. 8,096,647, titled “Solid ink sticks having a verification interlock for verifying position of a solid ink stick before identifying the ink stick”, which is hereby incorporated herein by reference in its entirety, refers to a verification interlock feature that can engage a displaceable member in a receptacle. Similarly, a material to be used in additive manufacturing can include a verification interlock feature to engage a corresponding member in an additive manufacturing system. In an example, the verification interlock feature can change over a length of the material, such as over a length of a filament material. A position of a material can be checked or verified before an authentication attempt is made. For example, Jones, in U.S. Pat. No. 8,052,265, titled “System and method for verifying position of an object before identifying the object”, which is hereby incorporated herein by reference in its entirety, describes a loader configured to verify a position and orientation of an ink stick prior to an ink stick identification operation.

A size, shape, dimension, cross-section, or other characteristic of a material can vary over a length of the material. For example, a first segment of the material (e.g., filament) can have a first cross-section shape, such as a circle, and a subsequent segment of the material can have a second cross-section shape, such as a hexagon. To verify the authenticity of the material, the additive manufacturing system or other device can use a variable aperture or other sensor that can detect a change in the cross-section shape of the material as the material passes through or over the sensor. Optionally, the length of the segments or the pattern or sequence of cross-section (or other dimension) changes over a length of the material can encode authentication information about the material.

For example, authentication can be based on multiple segment lengths that correspond to multiple different cross-section shapes. For example, a first authentic material can be identified when a first segment length (e.g., 10 centimeters) corresponds to a first shape, a subsequent segment length (e.g., 10 centimeters) corresponds to a second shape, and a further subsequent segment length (e.g., 10 centimeters) corresponds to the first shape. In this example, 30 centimeters of material can be used to provide the authentication information. Transitions between material profiles or cross-section shapes can be smoothed. In an example, the segment length of the smoothed portion can itself be used to provide authentication information.

FIG. 6 illustrates generally an example of a perspective view of a filament 600 that includes multiple segments having different cross-section characteristics. A first segment 601 includes a circular cross-section, a subsequent second segment 602 includes a rectangular cross-section, and a further subsequent third segment 603 includes a hexagonal cross-section. The filament 600 includes a first transition zone 611 between the circular and rectangular segments, and a second transition zone 612 between the rectangular and hexagonal segments. In an example, a length of one or more of the segments or transition zones can be used to provide information about an authenticity of the filament 600. An optical or mechanical sensor can be used to detect segment lengths or dimensional changes along the filament 600, and information from the optical or mechanical sensor can be used to provide authentication information, such as to a control circuit in an additive manufacturing system.

In an example, authentication can be based on a sequence of cross-section changes or other dimension changes. For example, a first segment can correspond to a first cross-section shape (e.g., a circle), a subsequent segment can correspond to a second cross-section shape (e.g., a square), and a further subsequent segment can correspond to a third cross-section shape (e.g., a hexagon). In this example, information about the sequence of cross-section shapes (e.g., circle-square-hexagon) can be used to authenticate the material. In an example, a combination of segment lengths and dimensional changes of the material can be used to authenticate the material.

Zinniel et al., in U.S. Pat. No. 6,085,957, titled “Volumetric feed control for flexible filament”, which is hereby incorporated herein by reference in its entirety, refers to using information about an effective cross section of a material filament, such as monitored or determined using a sensor or sensor system, to control a motor which in turn rotates feed rollers to advance the filament toward a nozzle tip of an additive manufacturing system. Zinniel et al. further refers to adjusting a speed of a feed roller to supply a constant flow rate of material to the application tip. In an example, authentication information can be provided based on the feed roller speed.

Material marking or surface feature information can be used for metering material usage. For example, Batchelder et al., in U.S. Pat. No. 8,658,250, titled “Encoded consumable materials and sensor assemblies for use in additive manufacturing systems”, which is hereby incorporated herein by reference in its entirety, refers to material markings that are configured to be read by a sensor. Such markings can optionally be applied in a periodic or irregular pattern, and information about the pattern can be used for material authentication.

In an example, information about a material surface feature can be used to authenticate a material. For example, a material such as a filament or other substantially continuous material member can have at least one groove etched into its surface. The groove can be created at a time of manufacture (e.g., during extrusion), or in a downstream process, such as at the location of manufacture. At the point of use, such as in or near an additive manufacturing system, a mechanical sensor (e.g., a needle) or an optical sensor can be configured to identify the at least one groove and provide information about the authenticity of the material based on a characteristic of the groove. For example, information about a groove pattern, depth, shape, contour, or other groove characteristic can be measured to provide the information about the authenticity of the material. The groove can optionally follow a specified pattern along at least a portion of the material member, and the groove can have a fixed or a variable depth. In an example, one or more other authenticating characteristics can be provided in combination with the groove, such as at the base of the groove. For example, a unique chemical signature can be provided at a base or sidewall of the groove. The chemical signature can optionally be varied over the length of the groove.

Multiple different grooves can be used in parallel along some portion of a material. The grooves can have different segment lengths, depths, or other distinguishing characteristics that can be used to encode information about a material characteristic. In an example, an angular, linear, or other distance between adjacent grooves can be used to encode information.

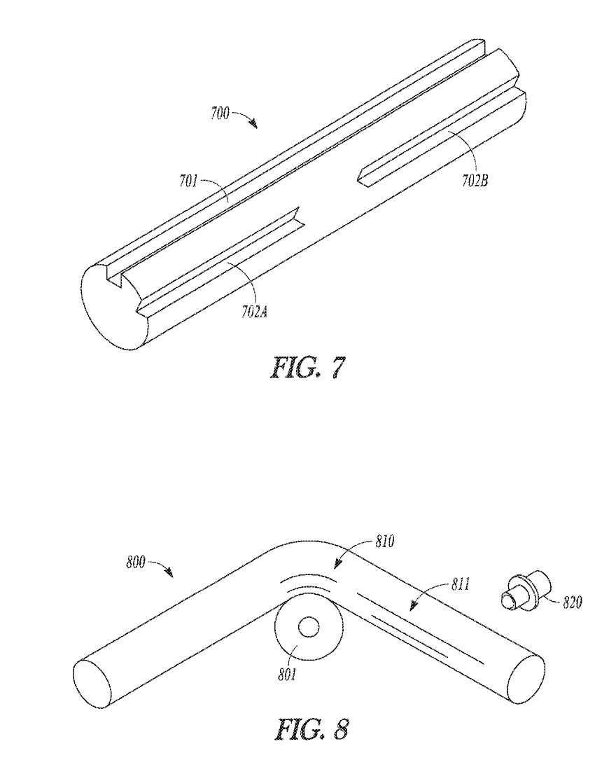

FIG. 7 illustrates generally an example of a perspective view of a segment of a filament 700 having a substantially circular cross-section. The filament 700 includes a first groove 701 in a portion of the outer surface of the filament 700. The first groove 701 has a substantially rectangular cross-section. The filament 700 includes a second groove 702A and a third groove 702B. The second and third grooves 702A and 702B have substantially triangular cross-sections. As shown in the example of FIG. 7, the second and third grooves 702A and 702B are collinear but discontinuous along the surface of the filament 700. Various characteristics of the filament 700 can be used to provide information about an authenticity of the filament 700. For example, information about a length of a groove segment, or information about a length of a discontinuity between adjacent groove segments, such as the discontinuity between the second and third grooves 702A and 702B, can be used to encode information about the authenticity. In an example, information about a depth of at least one of the first, second, and third grooves 701, 702A, and 702B can be used. In an example, information about an angle θ or a surface distance between the first groove 701 and the second groove 702A can be used.

In an example, information about a material surface characteristic can be used to authenticate a material. For example, a surface characteristic can include a material color or reflectivity characteristic. These characteristics can be measured at one or more stages in an additive manufacturing system, such as at loading of a material into a container, upon exiting or releasing a material from a container, or when passing the material through a specified portion of the system (e.g., at a nozzle cartridge).

In an example that includes using a characteristic material color, a material can have a known or specified color at a time of manufacture. The color can be configured to change predictably over time, such as in response to exposure to various environmental conditions such as light, air, particular gases, or other chemicals. Information about a material color, or a color change, can be used to authenticate the material.

In an example, a material color can be measured using an optical or chromatic sensor that is sensitive to one or more portions of a visible light spectrum. In other examples, a sensor can be used to observe information from various other, non-visible wavelengths of electromagnetic radiation, including in ultraviolet or infrared bands. An authenticity of a material can be verified by comparing the measured color or radiation wavelength to a known or reference value.

In an example, information about a reflection characteristic at a surface of a material can be used to authenticate a material. The reflection characteristic can correspond to a specified wavelength or range of wavelengths, such as over a portion of a visible and/or non-visible spectrum. A sensor disposed in or near an additive manufacturing system can be configured to measure an intensity or wavelength of reflected electromagnetic radiation information from a surface of a material under test, such as in response to stimulation by a specified light source. The source can include an LED, a halogen bulb, or other illumination device to emit light or other electromagnetic radiation in the direction of the material under test.

Alcock et al., in U.S. Pat. No. 7,218,386, titled “Detection of printing and coating media”, which is hereby incorporated herein by reference in its entirety, refers to an optically variable material (OVM) present in or on a surface of a material. Potyrailo et al., in U.S. Pat. No. 7,496,938, titled “Media drive with a luminescence detector and methods of detecting an authentic article”, which is hereby incorporated herein by reference in its entirety, refers to using a luminescence emission for authentication. Cronin et al., in U.S. Pat. No. 8,547,537, titled “Object Authentication”, which is hereby incorporated herein by reference in its entirety, refers to authenticating or validating an object using information about light scattering.

Cowburn, in U.S. Pat. No. 8,421,625, titled “System and method for article authentication using thumbnail signatures”, and in U.S. Pat. No. 8,757,493, titled “System and method for article authentication using encoded signatures”, which are hereby incorporated by reference in their entirety, refer to using information from scattered light to collect a large number of data points, and using the large number of data points to determine a digital signature that can be used for authentication.

In an example, information about a surface smoothness characteristic can be used to authenticate a material. A material can have a portion of its surface selectively roughened or etched to create portions having various degrees of smoothness. A value or quality of the surface smoothness can be detected optically, such as described above with respect to the reflection characteristic measurement. In an example, a value or quality of the surface smoothness can be detected mechanically using a sensor or probe that is configured to measure friction at the surface of the material.

In an example, information about a mechanical characteristic of a material can be used to authenticate a material. For example, a hardness (durometer), bend or deformation tolerance, electrical resistance or impedance, or other characteristic indicative of a material's mechanical or electrical properties can be used. Such a characteristic can be measured at one or more stages in an additive manufacturing system, such as at loading of a material into a container, upon exiting or releasing a material from a container, or when passing the material through a specified portion of the system (e.g., at a nozzle cartridge).

In an example, information about a material hardness or durometer can be used to authenticate a material. A mechanical test device can be configured to measure a surface hardness of the material by applying a needle, blade, or other instrument at a surface of the material. In an example, the mechanical test device can be configured to drag or scrape the instrument along a surface of the material as it passes under or through the test device. Based on a response of the material itself, as measured using the instrument or using an optical sensor, information about the material hardness can be measured and used to authenticate the material.

In an example, information about a material bend characteristic can be used to authenticate a material. A mechanical or optical sensor can be used to receive information about a bend characteristic, such as when a material under test is driven or pulled through or around a roller or other surface in an additive manufacturing system. A material path can include a series of rollers to bend the material at one or more different angles, and an authenticity of the material can be verified based on its ability to pass through the series of rollers, such as without breaking or exhibiting excessive strain. FIG. 8 illustrates generally an example of a setup for testing a material bend characteristic. In this example, an optical sensor 820 can be used to measure or observe strain or stress lines 810 or 811 that develop in a material filament 800 as the filament 800 passes around a roller 801. The strain or stress 810 or 811 lines can be used to provide information about an authenticity of the material. In an example, a bend radius of the material filament 800, such as in response to a known or constant applied force, can be measured, and information about the flexibility of the material filament 800 can be used to verify an authenticity of the material.

In an example, information about an electrical characteristic can be used to authenticate a material. For example, information about a material resistance or impedance, for example per unit length, can be used to authenticate a material. A sensor including one or more electrodes can be placed in a material path (e.g., at a portion of a material conduit, such as between a material supply and a nozzle cartridge) to measure an impedance characteristic of the material, such as while the material passes through the conduit. The impedance information can be measured continuously or at some specified interval.

A cross-section shape, density, or diameter of a material can influence an impedance or resistance characteristic of the material. In an example, an impedance characteristic of a material can be measured at multiple different locations along a length of a filament, and information about differences or changes in the measured impedance characteristic can be used to authenticate the material.

In an example, a material includes a dopant that influences an impedance characteristic of the material. The dopant level can be varied over a length of the material such that the measured impedance correspondingly varies over the length of the material. The sensor and/or a control circuit can be used to receive information about the impedance and use the received information to determine whether the material is authentic.

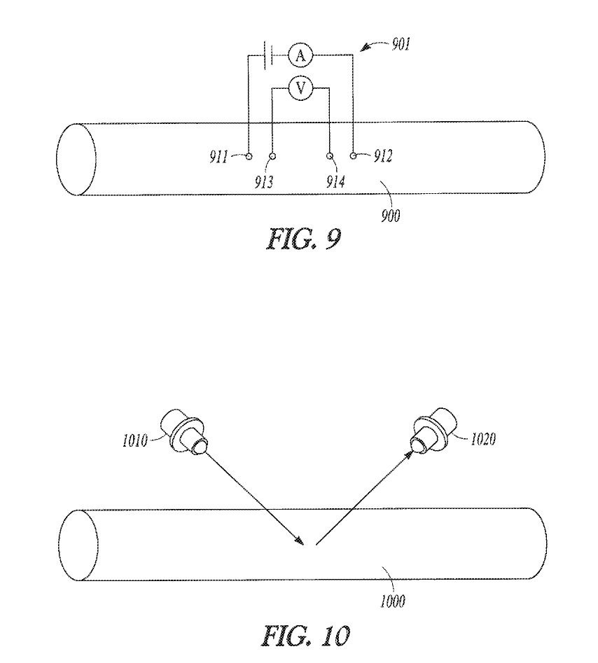

FIG. 9 illustrates generally an example of a material filament 900 under electrical test using a four point probe 901. The probe 901 is configured to deliver a test current using first and second electrodes 911 and 912, and the probe 901 is configured to measure a voltage, in response to the test current, using the third and fourth electrodes 913 and 914. A three point configuration can similarly be used. Information about the test current and the measured voltage can be used to determine characteristic impedance information about the filament 900, and the characteristic impedance information can be used to determine an authenticity of the material.

In an example, information about a material taggant can be used to authenticate a material. A taggant can include, among other things, a chemical taggant embedded in a material, ink applied at a surface of a material, a watermark, a fluorescence or luminescence characteristic (e.g., from the material itself or from an embedded material), a bar code, a material surface characteristic (a roughness or smoothness characteristic), or other indicia. Material authenticity can be determined based on a presence, absence, pattern, or other characteristic of the taggant, ink, barcode, watermark, or the fluorescent or luminescent characteristic. For example, Alestroem, in International Patent Application Publication Number WO1996/017954, titled “Chemical labeling of objects”, which is hereby incorporated herein by reference in its entirety, refers to encoding information using a chemical tag included in an object. Hayward et al., in U.S. Pat. No. 8,415,164, titled “System and method for secure document printing and detection”, which is hereby incorporated herein by reference in its entirety, refers to using nucleic acid for material authentication.

In an example, a taggant includes a material that is added to a thermoplastic or other extrudable material during the material manufacturing process. The taggant can be visually observable, including as a fluorescent or luminescent response to stimulation of the material using ultraviolet light, infrared radiation, x-ray radiation, or other radiation. Examples of detecting a taggant using x-ray fluorescence are included in Kaiser et al., in U.S. Pat. No. 6,501,825, titled “Methods for identification and verification”, in White, U.S. Pat. No. 4,445,225, titled “Encoding scheme for articles”, and in Kaiser et al., International Patent Application Publication No. WO2002/068945, titled “Methods for identification and verification”, which are hereby incorporated herein by reference in their entirety.

Polymers including taggants are discussed in Hubbard et al., in U.S. Pat. No. 6,514,617, titled “Tagging materials for polymers, methods, and articles made thereby”, which is hereby incorporated herein by reference in its entirety. Hubbard et al. discloses a tagging material that includes at least one organic fluorophore dye, at least one inorganic fluorophore, at least one organometallic fluorophore, at least one semi-conducting luminescent nanoparticle, or a combination thereof, wherein the tagging material has a temperature stability of at least about 350° C. and is present in a sufficient quantity such that the tagging material is detectible via a spectrofluorometer at an excitation wavelength in a range between about 100 nanometers and about 1100 nanometers.

A taggant can be observed when the material is in a solid, semi-solid, or liquid state. In an example, an observable or measurable characteristic of the material and/or taggant can change in response to different stimuli or based on a state of the material itself. For example, a first taggant can change color, or demonstrate different fluorescent or luminescent properties, in response to certain wavelengths of light or radiation, such as corresponding to different phases or states of the material (e.g., solid vs. liquid states).

FIG. 10 illustrates generally an example of a filament 1000 that includes a chemical or elemental taggant that can be detected using x-ray fluorescence. The filament 1000 can be stimulated by a radiation beam from an x-ray source 1010, and in response, a spectral response can be observed using a spectrometer 1020. Based on information in the spectral response, one or more chemical or elemental constituents can be identified from the portion of the filament 1000 that was tested. Information about the presence, absence, or concentration of a chemical or elemental constituent can be a characteristic that is used to identify an authenticity of the material.

In an example, multiple different taggants and/or stimulation sources can be used, and multiple different emission spectra can be used for authentication. West, in U.S. Pat. No. 5,005,873, titled “Marking of Articles”, which is hereby incorporated herein by reference in its entirety, refers to an identification technique using at least two fluorescent constituents in the material, and the constituents have different excitation spectra in the ultraviolet region of the spectrum and different emission spectra in the visible region of the spectrum.

In an example, authenticating and/or identifying a material can include using information about a chemical marking agent. Baque, in U.S. Pat. No. 8,590,800, titled “Method of authenticating and/or identifying an article”, which is hereby incorporated herein by reference in its entirety, refers to using such a chemical marking agent, such as can be substantially inseparably enclosed in a marker as a carrier and contain selected chemical elements and/or compounds in the form of marker elements, in concentrations based on an encryption code.

In an example, a taggant includes an ink or other substance applied or printed to a surface of a material, and information about a pattern or type of the applied ink can be used to authenticate a material. The amount of ink used can be small enough so as to not affect a part composite produced using the material, but the amount of ink applied can be sufficient so as to be identifiable by a sensor. In an example, microprinting can be used. The ink can have luminescent or fluorescent properties, such as can be observed using a sensor. The ink can include a detectable chemical or other marker. In an example, the ink can be applied in a particular manner to create a hologram, such as in response to one or more stimulators, and the hologram can be observable by a user or by one or more sensors.

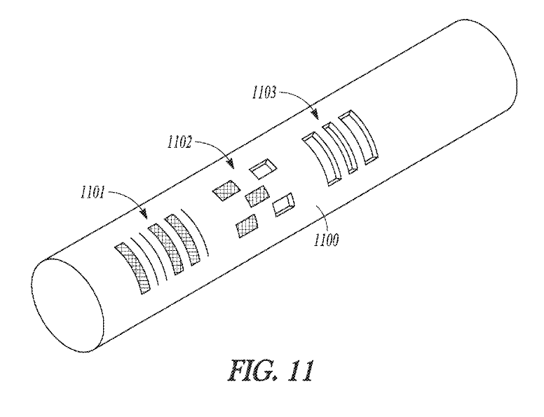

In an example, a taggant includes a bar code that is printed on or etched in a material, and information about the bar code can be used for authentication. A bar code can be one or two dimensional, or three dimensional where a depth of an etching in the material itself encodes information. A bar code can be printed using ink, using ultraviolet light (or other radiation) to cros slink the polymers in the material, or the code can itself be printed using an additive manufacturing system to deposit material on a filament or other raw material. FIG. 11 illustrates generally an example of a filament 1100 that includes bar code information. At 1101, the filament 1100 includes a bar code that is printed (e.g., using ink) on a surface of the filament 1100. At 1103, the filament 1100 includes a bar code that includes etched regions in the surface of the filament 1100. At 1102, the filament 1100 includes a multi-dimensional bar code that includes a combination of printed and etched regions.

In an example, a characteristic taggant includes one or more notches, bars, pixels, indentations, through holes, and the like, or any other surface deformation that is observable or measurable at a surface of a material. The notches, bars, pixels, indentations, through holes, etc. can optionally be arranged in a pattern similar to lines or pixels in a bar code. The taggant can be repeated at various points along the additive manufacturing material, such as periodically, intermittently, or randomly. The tag pattern itself can optionally be used to encode authentication information.

In an example, authentication information can be written to a filament material using irradiation techniques, such as described in Becker-Szendy et al., in U.S. Pat. No. 8,298,830, titled “Storing data on fiber data storage media”, which is hereby incorporated herein by reference in its entirety. The method described in Becker-Szendy includes, among other things, exposing a portion of a fiber to irradiation to change a characteristic (e.g., irradiation absorption, transparency, etc.) of the fiber.

In an example, information about a magnetic characteristic of a material can be used to authenticate a material. A magnetic characteristic of a material can be influenced or created by passing the material through an electric or magnetic field to encode information in the material by changing a magnetic property of the material.

In an example, the material can be coated with a material that is sensitive to or receptive to magnetic fields, and the coating material can be encoded with information, such as when the coating material is applied to the additive manufacturing material. The coating can optionally be melted together with the additive manufacturing material during a build event, or the coating can be stripped off of the material in the additive manufacturing system after the material is authenticated.

In an example, authentication information can be determined or derived using information about a material fingerprint. A material fingerprint can be created by measuring and recording characteristic information about the material at various points along a length of the material. The material characteristic can be measured at a time of material manufacture, or can be measured at another point in the material supply chain. Using the recorded characteristic information, the material can be authenticated by comparing later-measured characteristic information with the original or previously-recorded fingerprint information. The fingerprint information can be recorded on a tangible, non-transitory medium (e.g., a memory circuit) and can be accessible, such as using a network, by one or more additive manufacturing systems. For example, a material manufacturer can maintain a fingerprint database that can be queried, such as automatically, by an additive manufacturing system when the system is authenticating a new material for use. The authenticity of the material can be verified by measuring one or more characteristics of the material and then comparing the measured characteristics, or series of characteristics comprising the fingerprint, to the stored recorded characteristics. In an example, the fingerprint information can be used for authentication at one or more points along the material supply chain, such as when a bulk material is spooled and placed into a container, when the material is removed from a container, or when the material is otherwise handled, such as by a portion of an additive manufacturing system.

Fingerprint information can include material characteristic information collected from the material itself after the material is produced. In some examples, fingerprint information can include information obtained by encoding, calculating, mathematically altering, or performing a similar encoding or encrypting process to manipulate the material characteristic information collected from the material itself. That is, the information about the material characteristic can be encoded or encrypted in the fingerprint, and the encrypted fingerprint can be stored for later use. The fingerprint information can be encrypted using public key cryptography or using other cryptography techniques. Some examples of cryptographic verification using a public key are described in Simpson et al., International Patent Application Publication Number WO2013/062528, titled “Verification record for a replaceable supply”, which is hereby incorporated herein by reference in its entirety.

Various containers can be used for storing, shipping, or using additive manufacturing materials. Some types of containers include spools, cartridges, bays, canisters, hoppers, and the like. Alternatively or additionally to authenticating a material, such as described above, a container can be authenticated using the same or different authentication techniques. For example, techniques for authenticating a container can include using characteristic information about a container itself, or using characteristic information encoded in or applied to the container. Various system actions can be taken in response to an unauthenticated or unverified container, such as corresponding to different stages of an additive manufacturing system or material supply chain. Information about a container characteristic can be measured, compared, and verified using the same or similar methods as were described above for additive manufacturing materials. In response to an unauthenticated or unverified container, the container can be precluded from use in an additive manufacturing system.

In an example, a container-specific characteristic can be used for material authentication, or a combination of characteristic information about a container and a material in the container can be used together to provide authentication. For example, fingerprint information about a container and fingerprint information about a material can be used together and the material can be authenticated only when the fingerprint information from both the container and the material correspond.

Various types of material containers can be used. Some examples of suitable containers are shown in U.S. Pat. No. D436,111, titled “Filament cartridge”, in U.S. Pat. No. D650,787, titled “Filament spool container”, in U.S. Pat. No. 7,938,356, titled “Filament spool”, in U.S. Pat. No. 8,132,753, titled “Filament spool and filament spool container, and methods of use thereof”, in U.S. Pat. No. 8,403,658, titled “Consumable assembly for use in extrusion-based layered deposition systems”, and in U.S. Pat. No. 8,157,202, titled “Filament container and methods of use thereof”, which are hereby incorporated herein by reference in their entirety.

In an example, such as provided in Taatjes et al., U.S. Pat. No. 7,938,351, titled “Filament guide mechanism for filament spool container”, which is hereby incorporated herein by reference in its entirety, a container can include a sensor that is configured to detect a presence of a filament. Other sensors can similarly or additional be included, such as for material authentication.

In an example, a characteristic can be detected or measured as a material is unwound from a spool or otherwise removed from a material container. For example, as a filament is unwound from a spool, various characteristics of the filament—e.g. color, shape, diameter, groove, etc.—can be measured and compared to an expected or previously measured characteristic. In an example, the expected characteristic information can be provided based on a fingerprint or other information obtained from the material container or material spool itself.

In an example, a weight characteristic can be used. The weight characteristic can be based on one or both of a container weight and a material weight inside of the container. In some examples, a thickness or density of a filament in a container can vary along a length of the filament. Information about the thickness or density of the filament can thus be required to accurately determine or predict a weight of filament material in a container at any given time throughout a build process or other material consumption event. Characteristic weight information can be intermittently or continuously measured throughout a build event at an additive manufacturing system, and a material authentication parameter can be correspondingly updated throughout the build event. If, at any point during the build event, the characteristic weight information deviates from an expected weight, a counterfeit material can be indicated, and one or more system features can be changed or the system can terminate the build event.

In an example, an authentication characteristic can depend upon an amount of material remaining in a container or on a spool. For example, an angle at which a filament exits a spool or container can be measured and used as characteristic information about the material itself. That is, information about a winding pattern or winding angle can be used to authenticate the material. In an example, the angle can depend in part on one or more of a material stiffness, diameter of the spool (e.g., with or without the remaining material), rotational speed of the spool, or linear speed of the filament at the exit of the spool. As material is removed from the spool, the diameter of the remaining material decreases and can result in a change in an angle at which the filament exits from the spool or cartridge. Information about the angle or about the angle change can be used as characteristic information to determine an authenticity of a material.

Characteristic information can optionally be included at one or more specified sections of the filament (e.g., at an initial or first section). For example, characteristic information in a first or initial section of a filament can be used to indicate an algorithm that can be used for authenticating subsequent material as it is unwound from the spool. For example, information from a bar code at an initial segment of a material can be read and interpreted by a control circuit in an additive manufacturing system. The information from the bar code can include fingerprint information about one or more other characteristics of the material that can be monitored as the material is consumed. For example, the information from the bar code can include information about a material cross-section, material density, or other characteristic. The information about the material cross-section, material density, or other characteristic can be used throughout a build event to continuously or intermittently determine an authenticity characteristic of the material. In an example, the encoded characteristic or fingerprint information can be substantially continuously measureable or present throughout a length of a filament.

Some container-based authentication methods can be used to indicate or prevent reuse or refilling of a spool, cartridge, canister, or hopper with unauthenticated printing material. For example, Hashimoto, in U.S. Pat. No. 8,600,244, titled “New/used cartridge detection”, which is hereby incorporated herein by reference in its entirety, refers to devices, methods, and cartridge configurations that can be used to determine when a cartridge was previously used. Mushika et al., in U.S. Pat. No. 8,768,182, titled “Cartridge detection”, which is hereby incorporated herein by reference in its entirety, refers to a container protrusion for detection.

In some examples, a mechanical mechanism can be used to lock a container from reuse, such as by preventing a backward or reverse rotation of a spool. In an example, a rotation sensor can be provided to sense a number of rotations of spool during use, and information from the rotation sensor can be communicated to a control circuit in an additive manufacturing system to help identify whether a material from the spool is original or authentic. Reloading or reuse of a spool or container can require a special tool or machine to unlock a container or to enable reloading.

Electrical means can be similarly used. For example, Miller et al., in U.S. Pat. No. 7,286,774, titled “Universal Printer Chip”, which is hereby incorporated herein by reference in its entirety, refers to using a microcontroller to manage a message authentication code required by a printer. Gonzales, in U.S. Pat. No. 7,866,803, titled “Replaceable Printer Component with Electronic Tag”, which is hereby incorporated herein by reference in its entirety, refers to an electronic tag attached to a surface of a replaceable printer component.

In an example, an EEPROM device can be used to disable a spool or container for use in an additive manufacturing system such as when a printing material is indicated to be expired, when a maximum number of rotations is reached, or when a spool rotation reversal is detected. For example, a fuse in an EEPROM can be configured to irreversibly blow or break in response to some unauthorized event. The circuit in the EEPROM that includes the blown fuse can be monitored by an additive manufacturing system to determine whether a material associated with that EEPROM can be used.

Takimoto, in U.S. Pat. No. 7,708,395, titled “Liquid Container with Wireless Communication Antennas”, which is hereby incorporated herein by reference in its entirety, refers to a container that includes a memory for storing data. Cachia et al., in U.S. Pat. No. 8,554,090, titled “Replacement Printer Cartridge Chip with a Microcontroller with an Encrypted Memory Device”, which is hereby incorporated herein by reference in its entirety, refers to circuit or chip to enable using a replacement cartridge with a printer system. Douglas et al., in U.S. Patent Application Publication No. 2014/0117585, titled “Tagged build material for three-dimensional printing”, which is hereby incorporated herein by reference in its entirety, refers to a data tag, such as an RFID tag, that includes information about a build material.

In an example, a material container can include an RFID tag, security chip, or other electrical or magnetic tag, that can provide information to a control circuit in an additive manufacturing system. The RFID tag can be passive or active, and can optionally be programmable by a circuit included in an additive manufacturing system. Information from the RFID tag or chip can be used to calibrate or define an authentication algorithm that can be used to authenticate material that is received from the container that includes the RFID tag or chip. For example, information from the RFID tag or chip can be used to provide a fingerprint for use in authenticating a material.

In an example, the security chip can include a secure cryptographic processor, such as a smart card, and can include a digital signature, such as can be generated a time of manufacture of the security chip, at a time when the security chip is added to or coupled with a material container, or at a time when the container is filled with a material for use in additive manufacturing. Walmsley, in U.S. Patent Application Publication No. 2004/0049468, titled “Authentication of Consumable Items”, which is hereby incorporated herein by reference in its entirety, refers to using random number encryption techniques. Adkins et al., in U.S. Pat. No. 7,788,490, titled “Methods for Authenticating an Identity of an Article in Electrical Communication with a Verifier System”, which is hereby incorporated herein by reference in its entirety, refers to methods for authentication that include encrypting an identification code using a predetermine algorithm.

In an example, a container or a material in a container can be authenticated using a gas-filled container. When the container is inserted into an additive manufacturing system, a portion of the gas in the container can be released and sensed using a gas sensor of the system. If the correct gas type or gas concentration is detected, then the container and/or the material can be authenticated. In an example, a central location can be used to house large spools of material to supply a large number of additive manufacturing systems, such as via vacuum feed lines. A gas concentration at the central location or at an inlet to a specified one of the additive manufacturing systems can be sensed to authenticate a material.

Polymeric materials that can be used according to the systems, devices, and methods described herein can include high-performance engineering thermoplastic polymers such as polycarbonate-based polymers (PC), polymethyl methacrylate polymers (PMMA), polyethylene terephthalate polymers (PET), polybutylene terephthalate polymers (PBT), styrene polymers, polyetherimide (PEI, Ultem), acrylic-styrene-acrylonitrile polymers (ASA), and acrylonitrile-butadiene-styrene polymers (ABS). Engineering thermoplastic polymers can be used because they have a relatively high flexural modulus. Other materials for use according to the systems, devices, and methods described herein can include those described by any of (1) Hocker, in U.S. Provisional Patent Application No. 62/085,833, titled “ADDITIVE MANUFACTURING PROCESS AUTOMATION SYSTEMS AND METHODS”; (2) Hocker, in U.S. Provisional Patent Application No. 62/085,843, titled “NOZZLE TOOL CHANGING FOR MATERIAL EXTRUSION ADDITIVE MANUFACTURING”; or (3) Roviaro et al., in U.S. Provisional Patent Application No. 62/085,849, titled “RAPID NOZZLE COOLING FOR ADDITIVE MANUFACTURING”, each of which is hereby incorporated by reference in its entirety.

### Various Notes & Examples

Example 1 can include or use subject matter (such as an apparatus, a method, a means for performing acts, or a device readable medium including instructions that, when performed by the device, can cause the device to perform acts), such as can include or use a method for authenticating a build material for use in an additive manufacturing system, the method comprising receiving a build material, from a material container, at a material input of the additive manufacturing system, the build material including a filament strand, sensing information about a characteristic of the build material using a sensor, comparing the sensed information about the characteristic of the build material to a reference characteristic, determining an authentication score based on the comparison of the sensed information and the reference characteristic, enabling or disabling a portion of the additive manufacturing system in response to the determined authentication score.

Example 2 can include, or can optionally be combined with the subject matter of Example 1, to optionally include enabling or disabling one of a liquefier assembly or a drive assembly at an extrusion head assembly of the system.

Example 3 can include, or can optionally be combined with the subject matter of one or any combination of Examples 1 or 2 to optionally include locking out at least one drive assembly in the system.

Example 4 can include, or can optionally be combined with the subject matter of Example 3, to optionally include querying a user or a remote server for an unlock code to enable subsequent use of the additive manufacturing system.

Example 5 can include, or can optionally be combined with the subject matter of one or any combination of Examples 1 through 4 to optionally include stimulating a sample of the build material using x-ray radiation, and wherein the sensing the information about the characteristic of the build material includes receiving, in response to the x-ray stimulus, spectral information indicative of an elemental constituent of the build material.

Example 6 can include, or can optionally be combined with the subject matter of one or any combination of Examples 1 through 5 to optionally include optically sensing information about a tag on a surface of the build material.

Example 7 can include, or can optionally be combined with the subject matter of Example 6, to optionally include optically sensing information about the tag on the surface of the build material, including optically sensing a printed or etched pattern at the surface of the build material.

Example 8 can include, or can optionally be combined with the subject matter of one or any combination of Examples 1 through 7 to optionally include, in the sensing the information about the characteristic of the build material, using a pair of electrodes to sense information about an electrical characteristic of a segment of the build material.

Example 9 can include, or can optionally be combined with the subject matter of one or any combination of Examples 1 through 8 to optionally include, in the sensing the information about the characteristic of the build material, mechanically or optically sensing a depth characteristic of a groove in a surface of the build material.

Example 10 can include, or can optionally be combined with the subject matter of one or any combination of Examples 1 through 9 to optionally include sensing the information about the characteristic of the build material, including sensing information about a variable magnetic field over a specified length of a segment of the build material.

Example 11 can include, or can optionally be combined with the subject matter of one or any combination of Examples 1 through 10 to optionally include receiving information about a material fingerprint from a remote server, and identifying the reference characteristic using the received information about the material fingerprint.

Example 12 can include, or can optionally be combined with the subject matter of one or any combination of Examples 1 through 11 to optionally include, in the sensing the information about the characteristic of the build material, using a sensor disposed at an interface between the material container and a material input port of the additive manufacturing system.

Example 13 can include, or can optionally be combined with the subject matter of one or any combination of Examples 1 through 12 to optionally include, in the sensing the information about the characteristic of the build material, using information from a container that includes that the build material.

Example 14 can include, or can optionally be combined with the subject matter of one or any combination of Examples 1 through 13 to optionally include, in the sensing the information about the characteristic of the build material, using a sensor disposed at an extrusion head assembly of the additive manufacturing system to sense information about a characteristic of a liquefied portion of the build material.

Example 15 can include, or can optionally be combined with the subject matter of one or any combination of Examples 1 through 14 to optionally include, in the determining the authentication score, determining a likelihood that the build material is a specified type of material or originates from a specified source.

Example 16 can include, or can optionally be combined with the subject matter of one or any combination of Examples 1 through 15 to optionally include, in the sensing the information about the characteristic of the build material, mechanically or optically sensing a cross-section shape of the build material.

Example 17 can include, or can optionally be combined with the subject matter of one or any combination of Examples 1 through 16 to optionally include, in the sensing the information about the characteristic of the build material, optically sensing a reflectivity characteristic of the build material.

Example 18 can include or use subject matter (such as an apparatus, a method, a means for performing acts, or a device readable medium including instructions that, when performed by the device, can cause the device to perform acts), such as can include or use an additive manufacturing system comprising a build material input, a material sensor configured to sense characteristic information about a build material inserted in the additive manufacturing system via the build material input, a processor circuit configured to receive the sensed characteristic information from the material sensor and compared the received characteristic information to reference characteristic information, and an extrusion head assembly configured to dispense the build material when the processor circuit determines that the received characteristic information and the reference characteristic information sufficiently correspond.

Example 19 can include, or can optionally be combined with the subject matter of Example 18, to optionally include, as the material sensor, an optical or mechanical sensor that is configured to sense characteristic information about a shape of the build material.

Example 20 can include, or can optionally be combined with the subject matter of one or any combination of Examples 18 or 19 to optionally include, as the material sensor, an optical sensor that is configured to sense characteristic information about a reflectivity of a surface of the build material.

Example 21 can include, or can optionally be combined with the subject matter of one or any combination of Examples 18 through 20 to optionally include, as the material sensor, an optical or mechanical sensor that is configured to sense characteristic information about a groove in a surface of the build material.

Example 22 can include, or can optionally be combined with the subject matter of one or any combination of Examples 18 through 21 to optionally include, as the material sensor, an optical or mechanical sensor that is configured to sense characteristic information about a stress or strain evident at a surface of the build material.

Example 23 can include, or can optionally be combined with the subject matter of one or any combination of Examples 18 through 22 to optionally include, as the material sensor, an electrical sensor that is configured to sense characteristic information about an impedance of a segment of the build material.

Example 24 can include, or can optionally be combined with the subject matter of one or any combination of Examples 18 through 23 to optionally include, as the material sensor, a weight sensor that is configured to sense characteristic information about a weight of the build material or of a container that includes the build material.

Example 25 can include, or can optionally be combined with the subject matter of one or any combination of Examples 18 through 24 to optionally include, as the material sensor, a gas sensor that is configured to sense characteristic information about a gas included in a container that includes the build material.

Example 26 can include, or can optionally be combined with the subject matter of one or any combination of Examples 18 through 25 to optionally include, as the material sensor, an RFID communication circuit that is configured to exchange information with an RFID tag associated with a container of the build material.

In the event of inconsistent usages between this document and any documents so incorporated by reference, the usage in this document controls. Method examples described herein can be machine or computer-implemented at least in part. For example, the control circuit 190, or some other controller or processor circuit, can be used to implement at least a portion of one or more of the methods discussed herein. Some examples can include a tangible, computer-readable medium or machine-readable medium encoded with instructions that are operable to configure an electronic device to perform methods as described in the above examples. An implementation of such methods can include code, such as microcode, assembly language code, a higher-level language code, or the like. Such code can include computer-readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A method for authenticating a build material for use in an additive manufacturing system, the method comprising:
receiving a build material, from a material container, at a material input of the additive manufacturing system, the build material including at least one of a powder and a filament strand;
sensing information about a characteristic of the build material using a sensor;
comparing the sensed information about the characteristic of the build material to a reference characteristic;
determining an authentication score based on the comparison of the sensed information and the reference characteristic, wherein the determined authentication score includes a non-binary, relative indication about whether the sensed information corresponds to an authentic material from a specified source; and
enabling or disabling a portion of the additive manufacturing system in response to the determined authentication score.

2. The method of claim 1, wherein the enabling or disabling the portion of the additive manufacturing system includes enabling or disabling one of a liquefier assembly or a drive assembly at an extrusion head assembly of the system.

3. The method of claim 1, wherein the enabling or disabling the portion of the additive manufacturing system includes locking out at least one drive assembly in the system.

4. The method of claim 3, further comprising querying a user or a remote server for an unlock code to enable subsequent use of the additive manufacturing system.

5. The method of claim 1, comprising stimulating a sample of the build material using x-ray radiation using an x-ray source , and wherein the sensing the information about the characteristic of the build material includes receiving, in response to the x-ray stimulus and using a spectrometer, spectral information indicative of an elemental constituent of the build material.

6. The method of claim 1, wherein the sensing the information about the characteristic of the build material includes optically sensing information about a tag on a surface of the build material using an optical sensor.

7. The method of claim 6, wherein the build material includes the filament strand, and wherein the optically sensing information about the tag on the surface of the filament strand includes optically sensing a printed or etched pattern at the surface of the filament strand using the optical sensor.

8. The method of claim 1, wherein the build material includes the filament strand, and wherein the sensing the information about the characteristic of the filament strand includes using a pair of electrodes to sense information about an electrical characteristic of a segment of the filament strand.

9. The method of claim 1, wherein the build material includes the filament strand, and wherein the sensing the information about the characteristic of the filament strand includes mechanically or optically sensing a depth characteristic of a groove in a surface of the build material filament strand.

10. The method of claim 1, wherein the build material includes the filament strand, and wherein the sensing the information about the characteristic of the filament strand includes sensing information about a variable magnetic field over a specified length of a segment of the filament strand.

11. The method of claim 1, further comprising receiving information about a material fingerprint from a remote server, and wherein the comparing the sensed information about the characteristic of the build material to a reference characteristic includes identifying the reference characteristic using the received information about the material fingerprint.

12. The method of claim 1, wherein the sensing the information about the characteristic of the build material includes using a sensor disposed at an interface between the material container and a material input port of the additive manufacturing system.

13. The method of claim 1, wherein the sensing the information about the characteristic of the build material includes using information from a container that includes that the build material.

14. The method of claim 1, wherein the sensing the information about the characteristic of the build material includes using a sensor disposed at an extrusion head assembly of the additive manufacturing system to sense information about a characteristic of a liquefied portion of the build material.

15. The method of claim 1, wherein the determining the authentication score includes determining a confidence level that the build material includes a specified type of material.
